(19) United States
(12) Patent Application Publication
(10) Pub. No.: US 2005/0102701 A1
(43) Pub. Date: May 12, 2005

(54) Attention parental switch system of video/audio device

(76) Inventors: Charlie Kon-Yau Lin, Irvine, CA (US); Jim Chang, West Covina, CA (US); David H. Tan, El Monte, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/704,779

(22) Filed: Nov. 12, 2003

(51) Int. Cl. H04N 7/173; H04N 5/44; H04N 5/91

(52) U.S. Cl. 725/100; 725/131; 348/725; 725/151

(57) ABSTRACT

An attention parental switch system of video/audio device includes a button group, a function selection circuit, a microprocessor, an input control circuit, a central processor member, an audio control circuit and a video control circuit. The button group includes a change-over button and other button, such as volume button, power button. The input control circuit processes the signal coming from the button group and produces an output signal. The central processor member includes a central processor, ROM and RAM, program that the central processor runs and attention information data are stored in the ROM in advance. When a user pushes the change-over button, the central processor can cut off the audio input, at the same time, the central processor processes the attention information data and converts it into video signal to be outputting; the user pushes the change-over button again, audio signal will output again, and the central processor processes stops processing the attention information data.

### BACKGROUND OF THE INVENTION

1. Field of the Invention

The invention relates to an attention parental switch system of video/audio device. More particularly, the invention relates to an attention parental switch system of video/audio device that cuts off the audio information.

2. The Related Art

With the development of science and technology, various video/audio devices have appeared, particularly, in-vehicle multimedia devices are now popular among consumers. Video/audio devices have many other functions that are at the control of the user, such as power function, volume control function, and they make the users being entertained. However, the use of these video/audio devices may bring about some potential social problems because it is possible that there are inappropriate segments for children to be broadcasted in the video/audio device, such as the action of violence or horror, and the user can't ascertain when the inappropriate actions for children appear. As children do not have the ability of discrimination and judgment, if the children receive the actions when the video/audio device is used, it may cause the bad result for them. There is an increasing need for an attention parental switch system of video/audio devices that overcomes the above-mentioned deficiencies.

### SUMMARY OF THE INVENTION

An object of the present invention is to provide an attention parental switch system of video/audio device that achieves to cut off the audio information which is inappropriate for children to be exposed to.

To achieve the above objective, the present invention provides an attention parental switch system of video/audio device which includes a button group, function selection circuit, a microprocessor, signal control circuit, a central processor member, audio control circuit and video control circuit. The button group comprises of a change-over button and other buttons, such as a volume button and a power button. The central processor member has a central processor, ROM and RAM, programs that the central processor run and attention information data such as “ATTENTION, PRESS ATT TO RESUME” are stored on the ROM beforehand, and the temporary data that is produced during the operation of the central processor is stored in the RAM.

When the change-over button is pushed, a switch signal is produced. The function selection circuit receives the switch signal from the button group and outputs the encoding signal in response to the button signal. The encoding signal is inputted onto the micro-processor, and then the micro-processor outputs the control operation signal. The central processor receives the control operation signal and does an operation according to the control operation signal to allow the audio control circuit to cut off the output of audio. At the same time, the central processor receives and processes the attention data from the ROM. Then through the video circuit, the video signal corresponding to the attention data is outputted. If the change-over button is pushed again, the central processor makes the audio circuit to output the audio signal again and stops processing the attention information data.

Further, the remote control device may be provided, and the remote control device includes a remote control change-over button, control circuit, and a wireless emitter. In order to achieve control of the video/audio device, a wireless receiver that connects to the function selection circuit is also needed. The user can control the video/audio device by means of remote control.

### BRIEF DESCRIPTION OF THE DRAWINGS

The present invention will be apparent to those skilled in the art of reading the following description of embodiments thereof, with reference to the attached drawings, in which:

FIG. 1 is a block diagram of the first embodiment according to the present invention;

FIG. 2 is a block diagram of the second embodiment according to the present invention.

### DETAILED DESCRIPTION OF THE PREFERRED EMBODIMENT

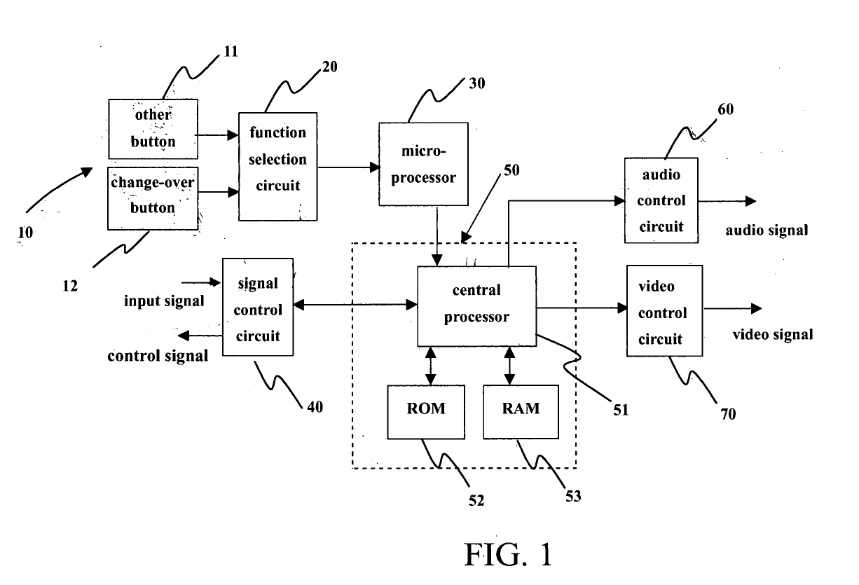

With reference to FIG. 1, an attention parental switch system of video/audio device of the present invention includes a button group 10, a function selection circuit 20, a microprocessor 30, a signal control circuit 40, a central processor member 50, an audio control circuit 60, and a video control circuit 70. Wherein the button group 10 comprises of a change-over button 11 and other buttons 12, such as the volume button and power button. The central processor member 50, has a central processor 51, ROM 52, and RAM 53. Programs that the central processor runs is stored in the in the ROM 52 in advance, attention information data such as “ATTENTION, PRESS ATT TO RESUME” are also stored on the ROM 52 beforehand, and the temporary data that is produced during the course of running of the central processor are stored in the RAM 53.

When a user presses one of the buttons of the button group, there will be a button signal produce. Then, the function selection circuit 20 receives the button signal and outputs the encoding signal that corresponds with the button signal. The encoding signal is inputted to the microprocessor 30, and the microprocessor 30 outputs the control operation signal according to the encoding signal. The central processor 51 receives and processes the control operation signal coming from the microprocessor 30 and then executes the corresponding operation to control the audio signal output coming from the audio control circuit 60 and video signal output coming from the video control circuit 70. There is a signal inputted to the signal control circuit 40. The signal contains audio information and video information. The signal control circuit 40 receives and converts the signal and produces the output signal for the central processor 51. The signal control circuit 40 also receives feedback signal from the central processor 51 and outputs control signal to control the signal inputted to the signal control circuit 40. The central processor 51 and other circuit (not shown in the figures) convert the signal from the signal control circuit 40 into audio signals inputted to the audio control circuit 60 and video signals inputted to the video control circuit 70. The audio control circuit 60 and the video control circuit 70 respectively outputs audio signals and video signals that can be displayed on the terminal device (not shown in the figures).

By the change-over button 11, the attention parental switch system of the video/audio device achieves to cut off the audio signal, that is to say the change-over button 10 is respondent with a switch mode. When a user is making use of the video/audio device, there are inappropriate materials shown on the video/audio device, such as the action of violence or horror, or a sign of those action appears, then the use pushes the change-over button 11 for the first time, after that a switch signal is produced. The function selection circuit 20 receives the switch signal and outputs the encoding signal in response to the switch signal. The encoding signal is put into the microprocessor 30, and the microprocessor 30 processes the encoding signal and outputs the control operation signal. The central processor 51 receives the control operation signal and cuts off the audio output from the audio control circuit in response to the control operation signal, but the signal inputted the signal control circuit 40 doesn't stop, and video signal from the video control circuit 70 doesn't cease either. At the same time, the central processor 51 gets the attention information data in the ROM and converts it into attention signal, and then the attention signal with above video signal is outputted by the video control circuit, so that the attention information and video information are displayed on the terminal device synchronously.

When the user considers that the inappropriate segment is over, he pushes the change-over button 11 again, the central processor 51 makes the corresponding operation according to the control operation signal coming from the microprocessor 30, and then the audio control circuit restores the output of audio signal, at the meantime, the central processor 51 stops processing the attention information data, and the video control circuit also ceases outputting the attention information, so the user can directly view the audio signal and avoid any inconvenience coming from other operations, such as the operation of shut-down.

According to the above-mentioned, if there are children to be present, when the audio information from the video/audio device contains inappropriate material for children, the user can cut off the broadcast of the audio information through the change-over button 11, so it is to be avoided receiving the inappropriate action for the children in present.

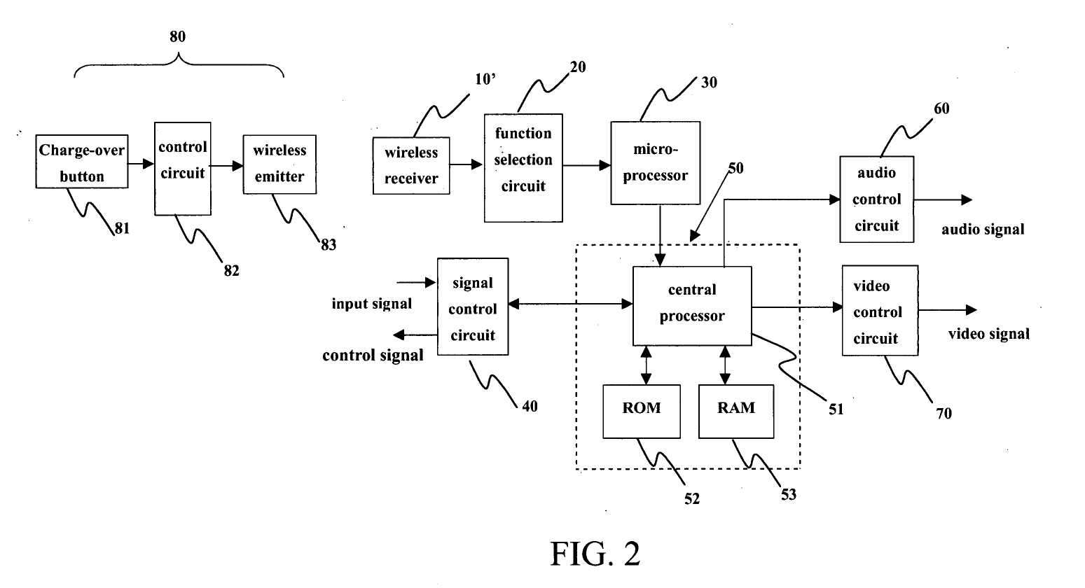

With reference to FIG. 2, the second embodiment of the present invention is shown. In the embodiment the attention parental switch system of video/audio device of the present invention includes a wireless receiver 10′, function selection circuit 20, a microprocessor 30, a signal control circuit 40, a central processor member 50, an audio control circuit 60, a video control circuit 70 and a remote controller 80. The central processor member 50 has a central processor 51, ROM 52 and RAM 53, the program that the central processor 51 runs and attention information data are stored in the ROM 52 beforehand, and the temporary data that produce in the process that the program runs is stored in the RAM 53. The remote controller 80 comprises a change-over button 81, a control circuit 82 and a wireless emitter 83.

If the user pushes the change-over button 81, there is a switch signal to be produced, and the switch signal is inputted to the control circuit 82. The control circuit 82 receives the switch signal and outputs the signal in response to the switch signal, and then the signal is converted into wireless signal by the wireless emitter 83. The wireless receiver 10′ receives the wireless signal from the wireless emitter 83 and converted it into an electrical signal. The electrical signal is inputted to the function circuit 20, and the function circuit 20 converted the electrical signal into the signal that the microprocessor 30 can receive. Then the microprocessor 30 outputted control operation signal according to the signal from the function circuit 20. The central processor 51 receives the control operation signal and then executes an operation to cut off the output of audio signal from the audio control circuit 60. Consequently, the user can control the video/audio device to cut off inappropriate action being displayed by the remote control device.

Although the present invention has been fully described by way of the examples with reference to the accompanying drawings, it is to be noted that various changes and modification will be apparent to those skilled in the art. Therefore, unless otherwise such changes and modifications depart from the scope of the present invention, they should be construed as being included therein.

1. An attention parental switch system of video/audio device, comprising:
a button group including a change-over button;
a function selection circuit receiving the switch signal from the button group and outputting encoding signal in response to said button signal;
a micro-processor processing said encoding signal and outputting control operation signal;
a signal control circuit receiving input signal and producing output signal;
a central control unit including a central processor, ROM and RAM, wherein the central processor receives said control operation signal from the micro-processor and said output signal from the signal control circuit, program that the central processor runs and attention information data are stored in the ROM in advance, and the temporary data that is produced during the course of running of the central processor is stored in the RAM;
an audio control circuit receiving the signal from the central processor and outputting audio signal; and
a video control circuit receiving the signal from the central processor and outputting the video signal;
wherein the change-over button is pushed, the central processor controls the audio control circuit to cut off the output of said audio signal, and at the same time, the central processor gets the attention data from the ROM and processes said attention data and then outputs the video signal corresponding to the attention data; the change-over button is pushed again, the central processor controls the audio control circuit to output audio signal again, at the same time, the central processor stops processing said attention information data and outputting the video signal corresponding to said attention information data.

2. An attention parental switch system of video/audio device, comprising:
a remote control device including a remote control change-over button, control circuit and an emitter terminal, wherein said control circuit receives the switch signal from the remote control change-over button and outputs the signal, and then the emitter terminal emits the wireless signal in response to the signal from the control circuit.
a wireless receiver receiving the wireless signal emitted from the wireless emitter and converting said wireless signal into an electric signal.
a function selection circuit receiving said electric signal and outputting encoding signal in response to said button signal;
a micro-processor processing said encoding signal and outputting control operation signal;
a signal control circuit receiving input signal and producing output signal;
a central control unit including a central processor, ROM and RAM, wherein the central processor receives said control operation signal from the micro-processor and said output signal from the signal control circuit, program that the central processor runs and attention information data are stored in the ROM in advance, and the temporary data that is produced during the course of running of the central processor is stored in the RAM;
an audio control circuit receiving the signal from the central processor and outputting audio signal; and
a video control circuit receiving the signal from the central processor and outputting the video signal;
wherein the change-over button is pushed, the central processor control the audio control circuit to cut off the output of said audio signal, and at the same time, the central processor gets the attention data from the ROM and processes said attention data and then outputs the video signal corresponding to the attention data; the change-over button is pushed again, the central processor control the audio control circuit to output audio signal again, at the same time, the central processor stops processing said attention information data and outputting the video signal corresponding to said attention information data.
